(19) United States
(12) Patent Application Publication
(10) Pub. No.: US 2008/0129578 A1
(43) Pub. Date: Jun. 5, 2008

(54) Buoyant Remote Control Unit for Swimming Pools and Spas

(75) Inventors: Kris Petersen, Providence, RI (US); Lloyd Slonim, Providence, RI (US); Robert D. Heon, Warwick, RI (US)

Correspondence Address: MCCARTER & ENGLISH, LLP, FOUR GATEWAY CENTER, 100 MULBERRY STREET, NEWARK, NJ, 07102, US

(73) Assignee: Hayward Industries, Inc.

(21) Appl. No.: 11/946,267

(22) Filed: Nov. 28, 2007

Related U.S. Application Data
(60) Provisional application No. 60/861,663, filed on Nov. 28, 2006.

(51) Int. Cl. H04L 17/02

(52) U.S. Cl. 341/176; 340/825.69

(57) ABSTRACT

The present disclosure relates to a buoyant remote control unit for swimming pools and spas. The unit includes interconnected front and back shell members having a printed circuit board positioned therebetween with electrical components for remotely controlling a pool or spa accessory. At least one button is overmolded to the front shell member to form a watertight seal between the button and the front shell member, the button operable to remotely control a pool or spa accessory. Top and bottom overmolds are formed on the front and back shell members, respectively, and a center overmold is formed on the front and back shell members. The top, bottom, and center overmolds provide a watertight seal for the remote control unit.

### RELATED APPLICATIONS

This application claims the benefit of U.S. Provisional Application Ser. No. 60/861,663, filed Nov. 28, 2006, the entire disclosure of which is expressly incorporated herein by reference.

### FIELD OF THE INVENTION

The present invention relates to remote control units that cooperate in the automatic operation of various diverse swimming pool and/or spa accessories.

### BACKGROUND OF THE INVENTION

Centralized control units for swimming pools and spas have existed in the past. Typically, such units are mounted at a location remote from the swimming pool or spa. A user can program the control units to automatically operate various different swimming pool and spa accessories, such as pumps, filters, heaters, lights, chlorinators, and cleaners. Programming may also be accomplished by using a portable, handheld, remote control unit, which is in radio frequency communication with the centralized control unit. Such remote control units are often designed to be buoyant so that they may be used in or around the pool or spa.

Existing remote control units suffer from various shortcomings. For example, it is difficult to ensure that the units will remain watertight during their operating life. If water is allowed to enter the unit, its internal electrical components will be damaged or destroyed. What is needed, therefore, is a buoyant remote control unit that is sufficiently waterproof so as to prolong its operating life.

### SUMMARY OF THE INVENTION

The problems and disadvantages associated with the prior art are overcome by the present invention, which relates to a wireless remote control unit for swimming pools and spas. The remote control unit includes a pair of shell members which, when joined together, house a printed circuit board therebetween. The joint between the two shell members is rendered waterproof by a center overmold, which prevents the replacement of the printed circuit board. Because the printed circuit board is not physically accessible, the remote control unit employs a rechargeable battery and RF “over-the-air” (OTA) updating software, which enables the unit's software to be remotely updated.

The electronic components of the remote control unit are controlled by a series of programmable buttons that are integrated into one of the shell members by an overmolding operation, which maintains the waterproof feature of the unit. One of the shell members is provided with an overmold that includes feet and a gripping surface, while the other shell member is provided with a separate overmold that enhances the gripability of the unit. If the shell members are made from a transparent material, their associated overmolds would be made from an opaque material so that the internal components of the remote control unit are masked.

Further features and advantages of the invention will appear more clearly on a reading of the detailed description of the exemplary embodiment of the invention, which is given below by way of example only with reference to the accompanying drawings.

### BRIEF DESCRIPTION OF THE DRAWINGS

For a better understanding of the present invention, reference is made to the following detailed description of the exemplary embodiment considered in conjunction with the accompanying drawings, in which:

FIG. 1 is an exploded perspective view, looking from below, of a swimming pool/spa remote control unit constructed in accordance with an exemplary embodiment of the present invention;

FIG. 2 is a top perspective view of a front shell member used to make the remote control unit shown in FIG. 1;

FIG. 3 is a bottom perspective view of the front shell member depicted in FIG. 2;

FIG. 4 is a top perspective view of the front shell member depicted in FIG. 2, but after the performance of a first overmolding operation to incorporate a button group therewith;

FIG. 5 is a bottom perspective view of the overmolded front shell member depicted in FIG. 4;

FIG. 6 is a top perspective view of the button group illustrated in FIG. 4, the button group being shown without the front shell member;

FIG. 7 is a bottom perspective view of the button group shown in FIG. 6;

FIG. 8 is a top perspective view of the overmolded front shell member depicted in FIG. 4, but after the performance of second overmolding operation to incorporate a top overmold;

FIG. 9 is a top plan view of the overmolded front shell member illustrated in FIG. 8;

FIG. 10 is a cross-sectional view, taken along section line 10-10 and looking in the direction of the arrows, of the overmolded front shell member illustrated in FIG. 9;

FIG. 11 is a cross-sectional view, taken along section line 11-11 and looking in the direction of the arrows, of the overmolded front shell member illustrated in FIG. 9;

FIG. 11A is an enlarged cross-sectional view showing, in schematic fashion, detail 11A from FIG. 11;

FIG. 12 is a cross-sectional view, taken along section line 12-12 and looking in the direction of the arrows, of the overmolded front shell member illustrated in FIG. 9;

FIG. 12A is an enlarged cross-sectional view showing detail 12A from FIG. 12;

FIG. 13 is a cross-sectional view, taken along section line 13-13 and looking in the direction of the arrows, of the overmolded front shell member illustrated in FIG. 9;

FIG. 13A is an enlarged cross-sectional view showing detail 13A from FIG. 13;

FIG. 14 is a top perspective view of a back shell member used to make the remote control unit shown in FIG. 1;

FIG. 15 is a bottom perspective view of the back shell member illustrated in FIG. 14;

FIG. 16 is a bottom perspective view of the back shell member depicted in FIG. 14, but after the performance of a third overmolding operation to incorporate a bottom overmold;

FIG. 17 is a top perspective view of a printed circuit board used to make the remote control unit shown in FIG. 1;

FIG. 18 is a top plan view of the remote control unit depicted in FIG. 1, but after its assembly and the performance of a fourth overmolding operation to incorporate a center overmold which makes the unit completely waterproof;

FIG. 19 is a cross-sectional view, taken along section line 19-19 and looking in the direction of the arrows, of the assembled remote control unit illustrated in FIG. 18; and

FIG. 20 shows the remote control unit of FIG. 19 with an LCD panel displaying visual data and with a schematic illustration of its operating environment.

### DETAILED DESCRIPTION OF THE EXEMPLARY EMBODIMENT

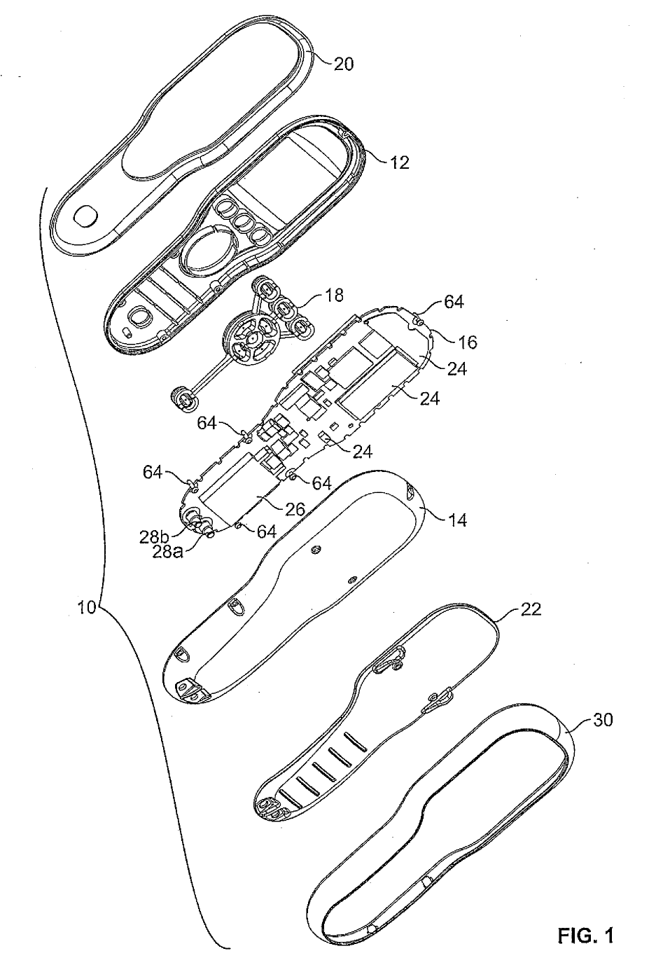

Referring to FIG. 1, a swimming pool/spa remote control unit 10 includes three primary components: a front shell member 12, a back shell member 14, and a printed circuit board 16. The front shell member 12 is provided with a button group 18, whose function will be described hereinafter, and with a top overmold 20, whose function will also be described hereinafter. The back shell member 14 is provided with a bottom overmold 22, which will be described in greater detail below. The printed circuit board 16 carries various electronic components 24, as well as a rechargeable battery 26 and a pair of recharging contacts 28a, 28b. After the assembly of the foregoing components in a manner to be described hereinafter, a center overmold 30 is applied for waterproofing purposes.

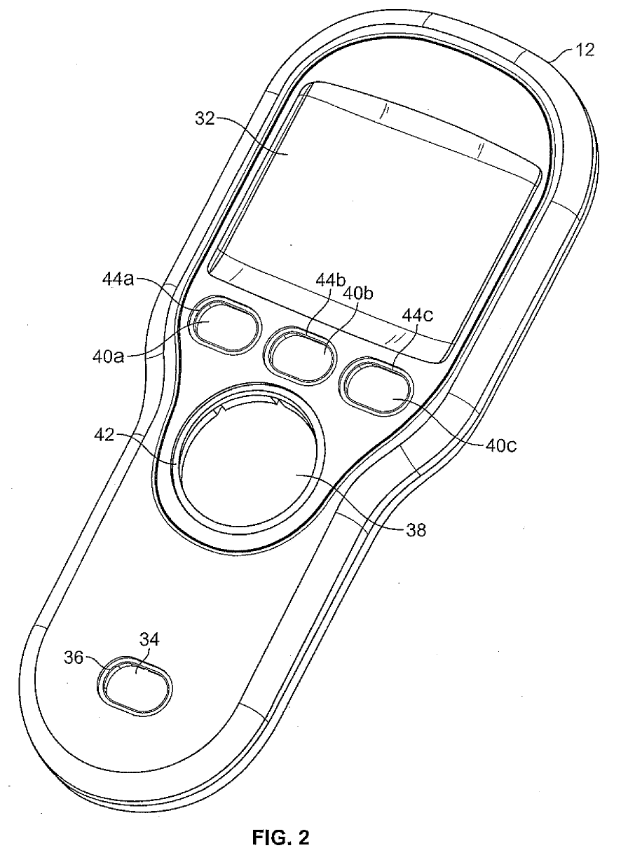

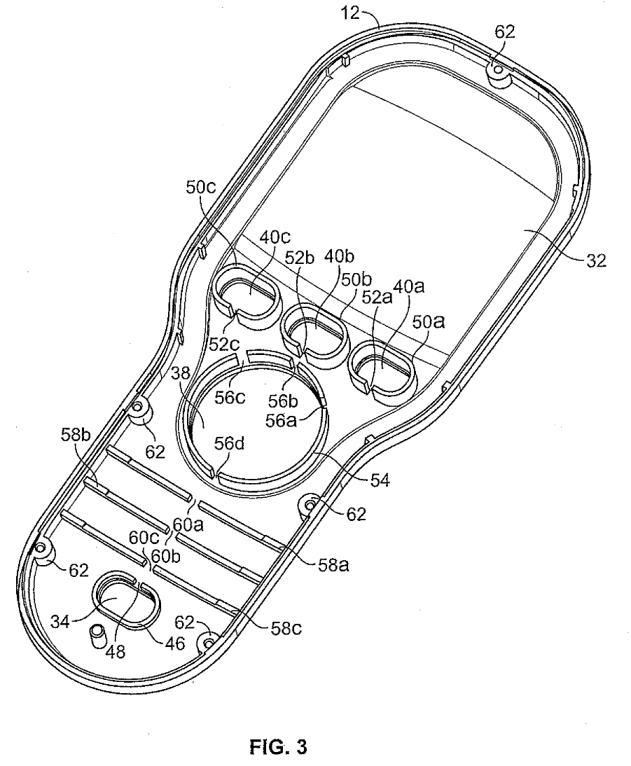

With reference now to FIGS. 2 and 3, the front shell member 12 is molded from an optically clear (i.e., transparent) plastic material, such as XYLEX® X8300 polycarbonate resin manufactured by GE Plastics, which is relatively rigid, but it can be made from other appropriate materials. The size and shape of the front shell member 12 are selected so as to accommodate a user's hand. A rectangular-shaped viewing screen 32 is located adjacent the wide end of the front shell member 12, while an oblong-shaped buttonhole 34 is located adjacent an opposite (i.e., narrow) end. A recessed ledge 36 extends around the buttonhole 34 on the topside of the front shell member 12 (see FIG. 2). The purpose of the ledge 36 will be explained below. A circular-shaped opening 38 and a series of three oblong-shaped buttonholes 40a, 40b, 40c are formed in the front shell member 12 intermediate its ends. A recessed ledge 42 extends around the opening 38, while recessed ledges 44a, 44b, 44c extend around the buttonholes 40a, 40b, 40c, respectively (see FIG. 2). The purpose of the ledges 42 and 44a, 44b, 44c will be explained below.

As shown in FIG. 3, the opening 38 and the buttonholes 34 and 40a, 40b, 40c extend through to the interior of the front shell member 12, where the buttonhole 34 is framed by an oblong-shaped rib 46 having a slot 48 for a purpose to be described below. Similarly, the buttonholes 40a, 40b, 40c are framed on the interior of the front shell member 12 by oblong-shaped ribs 50a, 50b, 50c, respectively, each of which has a corresponding slot 52a, 52b, 52c for a purpose to be described hereinafter, while a circular-shaped rib 54 frames the opening 38. The rib 54 is provided with slots 56a, 56b, 56c, 56d for purposes which will be described in greater detail hereinafter. Three linear ribs 58a, 58b, 58c extend across the interior of the front shell member 12 between the buttonhole 34 and the opening 38. Each of the linear ribs 58a, 58b, 58c has a corresponding slot 60a, 60b, 60c for a purpose to be described hereinafter. Several perimeter bosses 62 are arranged around the interior of the front shell member 12, each of the bosses 62 being internally threaded so as to receive a corresponding assembly screw 64 (see FIG. 1).

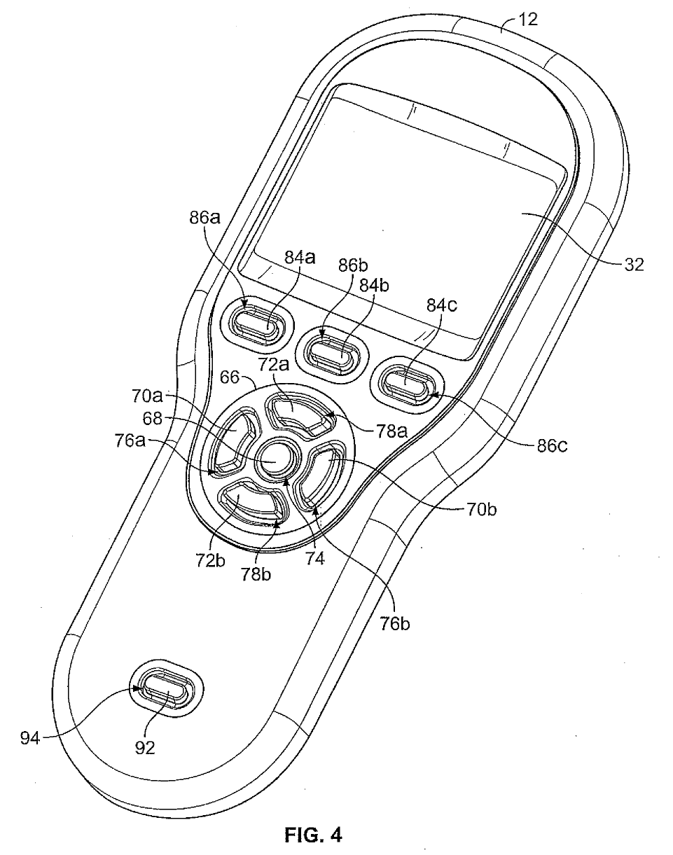

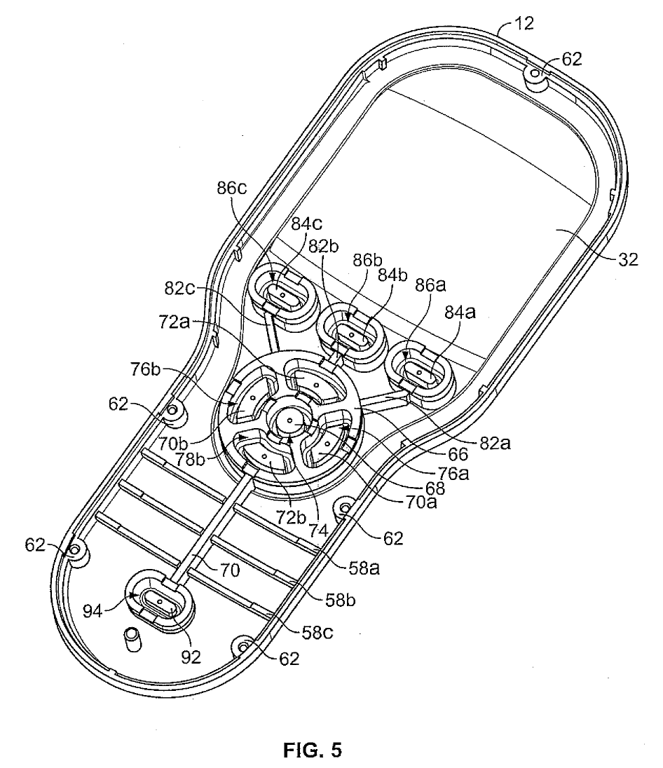

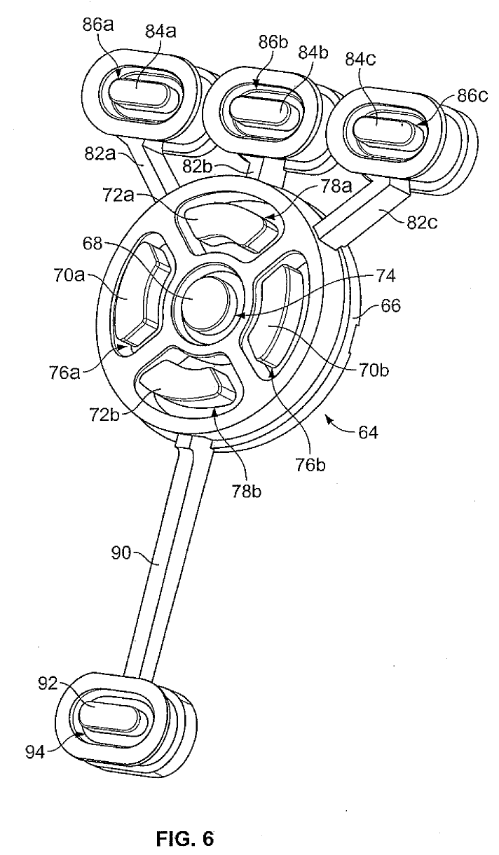

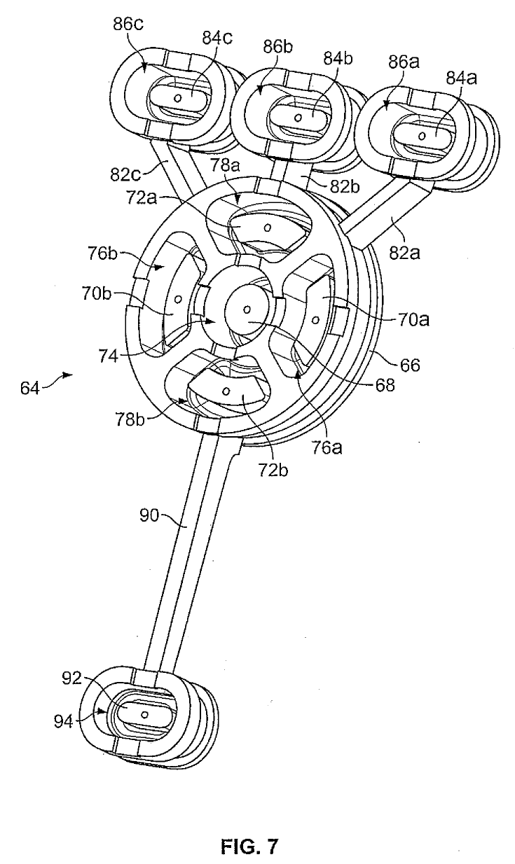

Referring now to FIGS. 4 and 5, as well as to FIGS. 6 and 7, the front shell member 12 is shown after the performance of a first overmolding operation, which is carried out to integrate the button group 18 (see FIGS. 6 and 7) into the front shell member 12. It should be understood that this overmolding operation is carried out using known injection molding techniques and materials which result in an essentially seamless (i.e., leak-proof) integration of the button group 18 with the front shell member 12. It should also be understood that the overmolding material is a softer and more resilient plastic than the relatively hard and rigid plastic chosen for the front shell member 12. For instance, the overmolding material plastic material may be manufactured from ONFLEX® K-6200-A40 styrenic block copolymer by PolyOne Corporation, but it can be made from other appropriate materials.

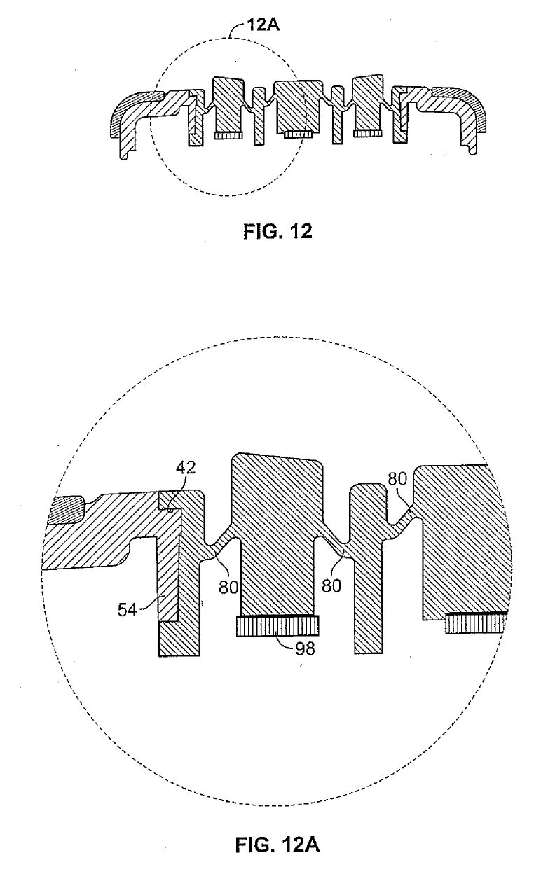

With the foregoing comments in mind, and with continued reference to FIGS. 4-7, the button group 18 includes a central hub 66 which is positioned within the opening 38 of the front shell member 12. The hub 66 has a menu button 68, a pair of navigation buttons 70a, 70b, and a pair of adjustment buttons 72a, 72b. The menu button 68 sits within a well 74 formed in the hub 66. In a similar fashion, the navigation buttons 70a, 70b sit within wells 76a, 76b, respectively, formed in the hub 66, which also includes another pair of wells 78a, 78b for the adjustment buttons 72a, 72b, respectively (see FIGS. 4 and 5). Each of the buttons 68, 70a, 70b, 72a, 72b is connected to a corresponding one of the wells 74, 76a, 76b, 78a, 78b by a thin web 80 of overmolding material (see FIGS. 12 and 12A) such that the buttons 68, 70a, 70b, 72a, 72b are individually depressible in response to engagement by a user's finger. The resiliency of the overmolding material allows the buttons 68, 70a, 70b, 72a, 72b to automatically return to their home (i.e., undepressed) position after they have been disengaged by the user. The adhesion (i.e., attachment) of the overmolding material to the front shell member 12 in the vicinity of the opening 38 is promoted by the ledge 42 (see FIG. 12A), as well as by the circular rib 54 (see FIG. 12A).

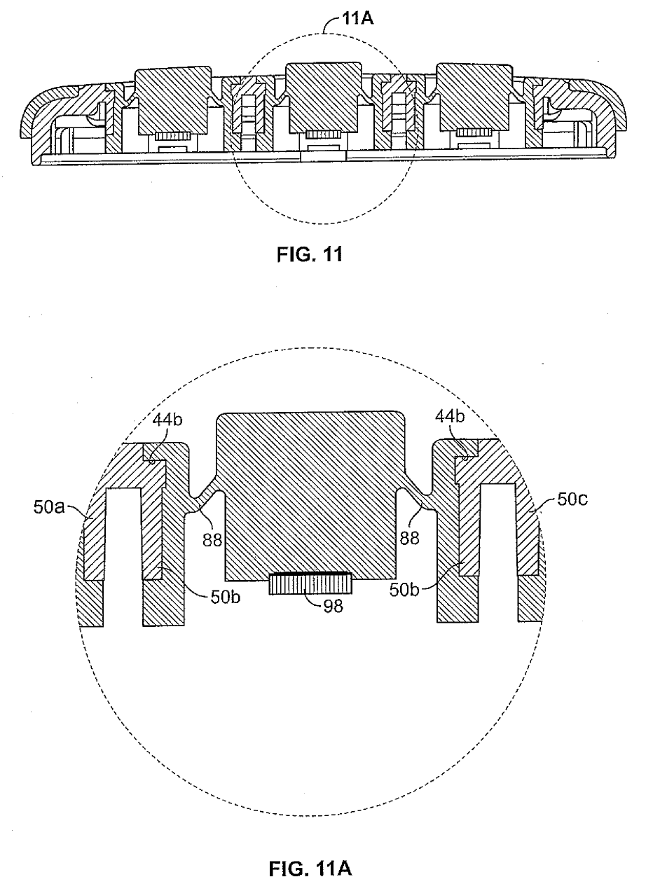

Arms 82a, 82b, 82c (see FIGS. 5-7) connect the hub 66 to selection buttons 84a, 84b, 84c, respectively, which sit within wells 86a, 86b, 86c positioned in the buttonholes 40a, 40b, 40c, respectively (see FIGS. 2 and 3). The arms 82a, 82b, 82c extend through the slots 56a, 56b, 56c, respectively, which are formed in the circular rib 54, and through the slots 52a, 52b, 52c, respectively, which are formed in their corresponding oblong ribs 50a, 50b, 50c (see FIG. 3). Each of the selection buttons 84a, 84b, 84c is connected to a corresponding one of the wells 86a, 86b, 86c by a thin web 88 of overmolding material (see FIGS. 11 and 11A) such that the selection buttons 84a, 84b, 84c are individually depressible in response to engagement by a user's finger. The resiliency of the overmolding material allows the selection buttons 84a, 84b, 84c to automatically return to their home (i.e., undepressed) position after they have been disengaged by the user. The adhesion (i.e., attachment) of the overmolding material to the front shell member 12 in the vicinity of the buttonholes 40a, 40b, 40c is promoted by the ledges 44a, 44b, 44c (see, for example, FIG. 11A), as well as by the oblong ribs 50a, 50b, 50c (see, for example, FIG. 11A).

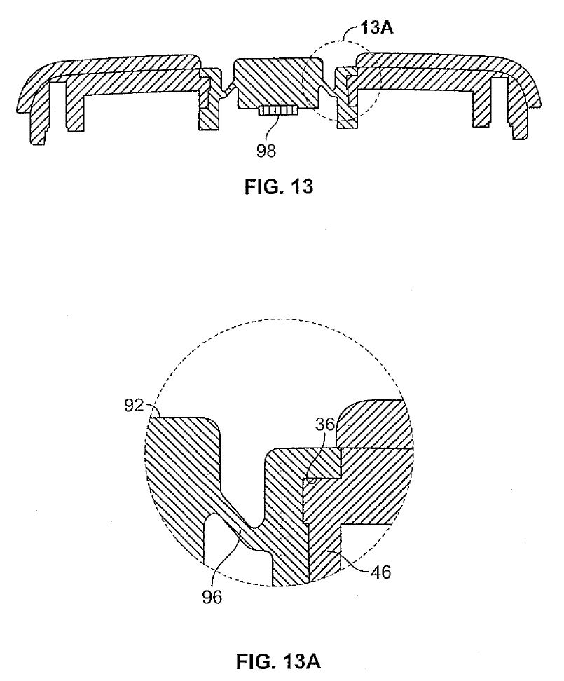

Another arm 90 (see FIGS. 5-7) connects the hub 66 to a shutoff button 92 which sits within a well 94 positioned in the buttonhole 34. The arm 90 extends through the slot 56d in the circular rib 54, through the slots 60a, 60b, 60c in the linear ribs 58a, 58b, 58c, and through the slot 48 in the oblong rib 46. The shutoff button 92 is connected to the well 94 by a thin web 96 of overmolding material (see FIGS. 13 and 13A) such that the shutoff button 92 is depressible in response to engagement by a user's finger. The resiliency of the overmolding material allows the shutoff button 92 to automatically return to its home (i.e., undepressed) position after it has been disengaged by the user. The adhesion (i.e., attachment) of the overmolding material to the front shell member 12 in the vicinity of the buttonhole 34 is promoted by the ledge 36 (see FIG. 13A), as well as by the oblong rib 46 (see FIG. 13A).

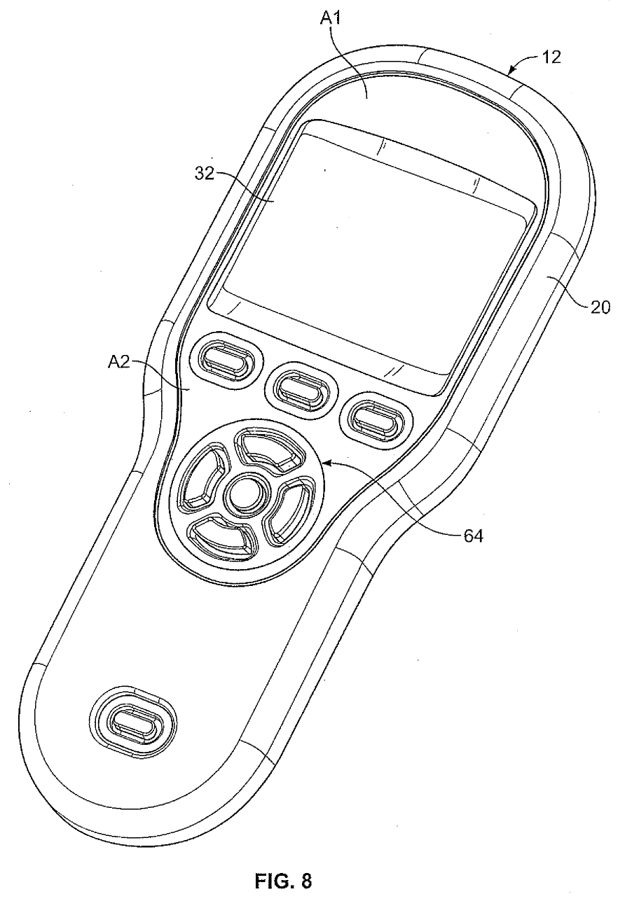

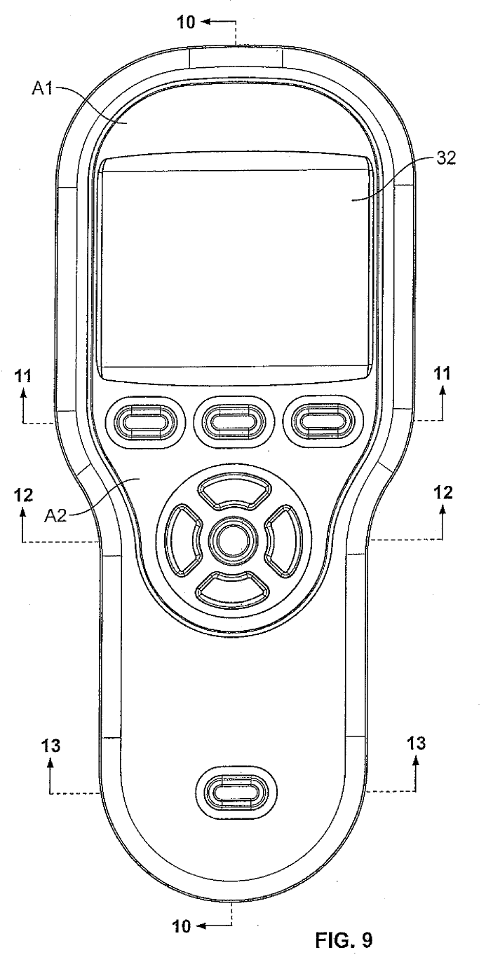

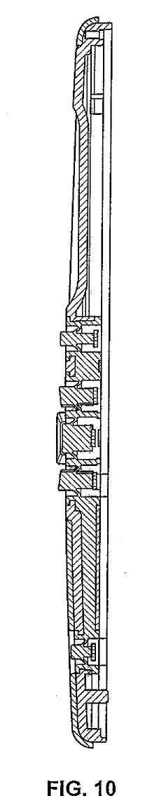

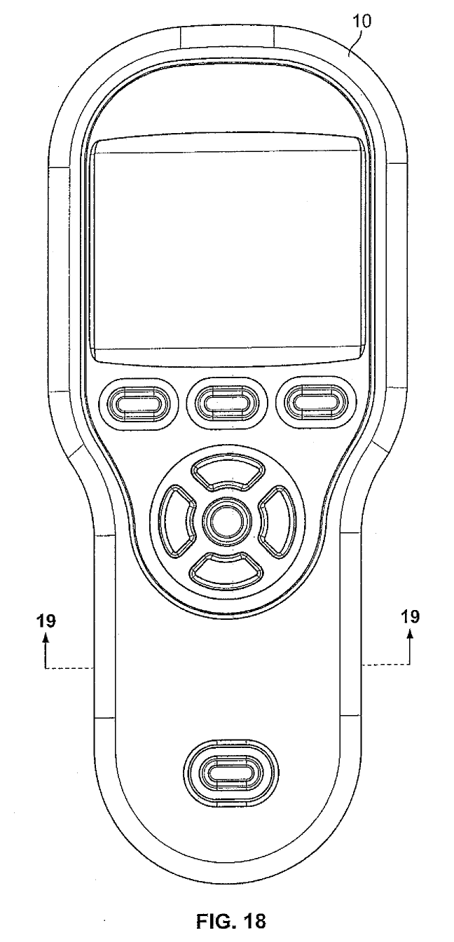

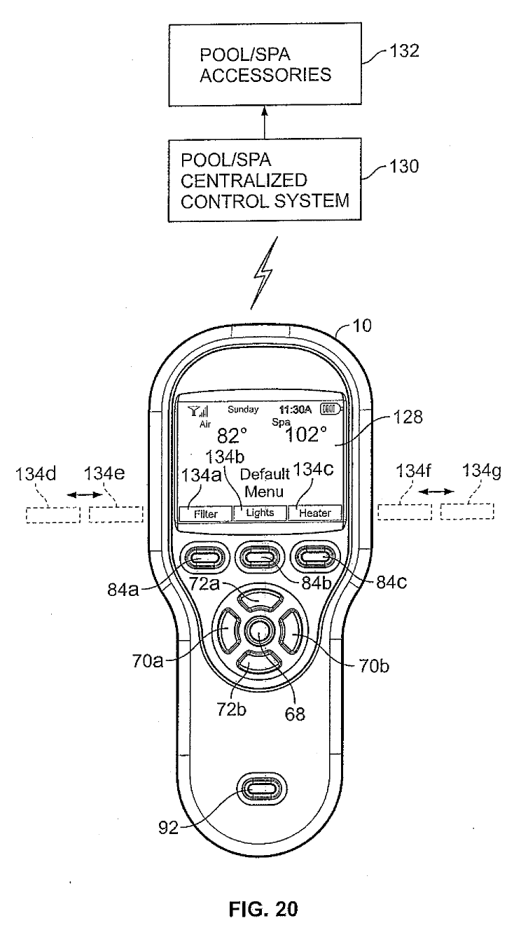

Referring to FIG. 8, the front shell member 12 is depicted after it has undergone a second overmolding operation in order to incorporate the top overmold 20 into the previously overmolded front shell member 12 shown in FIG. 4. Like the first overmolding operation, the second overmolding operation is carried out using known injection molding techniques and materials. The material for the top overmold 20 is softer than the relatively hard plastic chosen for the front shell member 12, thereby providing a more tactile feel. For instance, the top overmold 20 may be manufactured from ONFLEX® K-6200-A40 styrenic block copolymer by PolyOne Corporation, but it can be made from other appropriate materials. The material for the top overmold 20 is also chosen to be opaque so as to hide from view the internal components of the assembled remote control unit 10 (see, for example, FIGS. 18 and 20). Since FIG. 8 is essentially identical to FIG. 4, except for the addition of the top overmold 20, redundant reference numerals have been omitted from FIG. 8, as well as from other Figures showing the front shell member 12 after its second overmolding operation (i.e., FIGS. 9-13A). Besides the top overmold 20, FIGS. 8-13A show two other additional features not shown in FIGS. 1-7. One additional feature involves the provision of a conductor pad 98 on each of the buttons of the button group 18. The purpose of the conductor pads 98 is to allow the non-conductive buttons to make electrical contact with the electronic components 24 on the printed circuit board 16. The other additional feature involves the application of an opaque color onto the interior of the front shell member 12 in the areas A1 and A2 above and below the viewing screen 32 (see FIGS. 8 and 9). The opaque color can be applied using conventional spray painting techniques or any other suitable means. The opaque color applied to areas A1 and A2 hides from view the internal components of the assembled remote control unit 10.

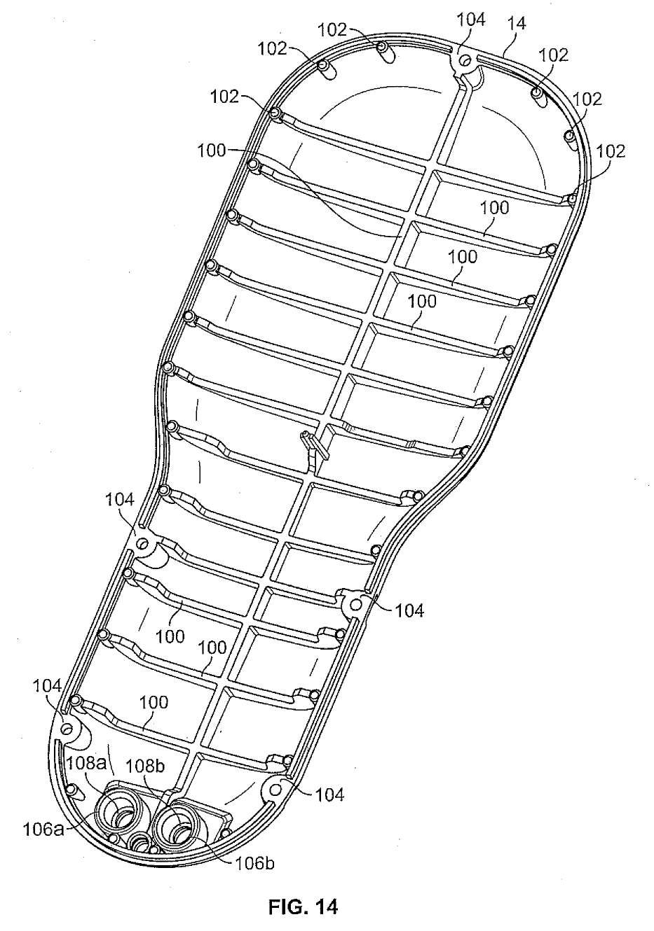

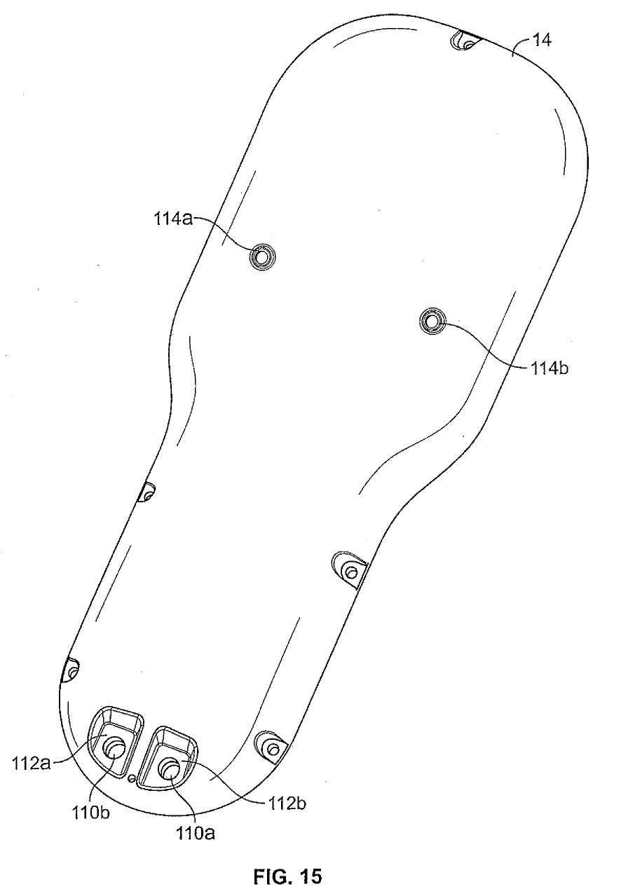

With reference now to FIGS. 14 and 15, the back shell member 14 is molded from an optically clear (i.e., transparent) plastic material, such as such as XYLEX® X8300 polycarbonate resin manufactured by GE Plastics, which is relatively rigid, but it can be made from other appropriate materials. The size and shape of the back shell member 14 are selected so as to accommodate a user's hand and are similar to those of the front shell member 12.

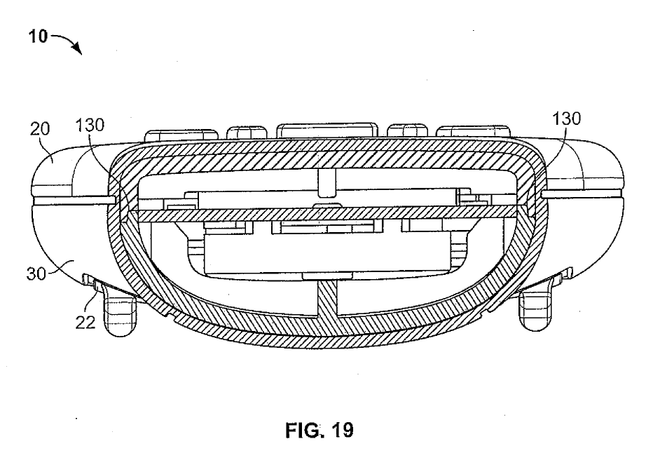

With particular reference to FIG. 14, the interior of the back shell member 14 is provided with a matrix of ribs 100 designed to support the printed circuit board 16 between the back shell member 14 and the front shell member 12 (see FIG. 19). Several perimeter posts 102 are arranged in the interior of the back shell member 14 for a purpose which will be explained below. The interior of the back shell member 14 also includes several molded-in bosses 104 which are arranged around the perimeter of the back shell member 14, each of the bosses 104 being internally threaded so as to receive a corresponding assembly screw 64 (see FIG. 1). It is noted that the arrangement of the bosses 104 aligns with the arrangement of the bosses 62 on the front shell member 12, such that each corresponding pair of bosses 62, 104 receives the corresponding assembly screw 64.

Referring to FIGS. 14 and 15, a pair of sockets 106a, 106b is provided in the interior of the back shell member 14 adjacent its narrow end, each of the sockets 106a, 106b being sized and shaped to receive a corresponding one of the recharging contacts 28a, 28b, as well as an associated O-ring (not shown in the Figures) which is provided for waterproofing purposes. Each of the sockets 106a, 106b includes an annular ledge 108a, 108b, respectively, (see FIG. 14) and an aperture 110a, 110b, respectively, (see FIG. 15) that extends completely through the back shell member 14. The annular ledges 108a, 108b maintain the position of the recharging contacts 28a, 28b (not shown in FIGS. 14 and 15, but see FIG. 1) while enabling them to remain exposed through the apertures 110a, 110b for electrical contact with a recharging unit (not shown in the Figures). A pair of notches 112a, 112b is formed in the external surface of the back shell member 14 adjacent the narrow end thereof. The external surface of the back shell member 14 includes a pair of annular projections 114a, 114b which extend outwardly therefrom. The purposes of the notches 112a, 112b and the annular projections 114a, 114b will be explained below.

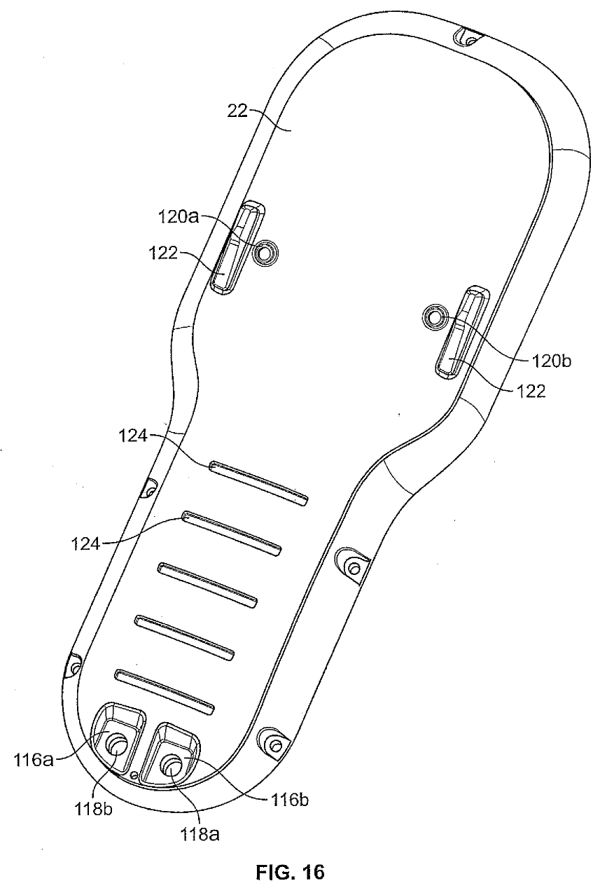

Referring to FIG. 16, the back shell member 14 is depicted after it has undergone a third overmolding operation in order to incorporate the bottom overmold 22 into the back shell member 14 shown in FIGS. 14 and 15. Like the first and second overmolding operations, the third overmolding operation is carried out using known injection molding techniques and materials. The material for the bottom overmold 22 is softer than the relatively hard plastic chosen for the front shell member 12, thereby providing a more tactile feel. For instance, the bottom overmold 22 may be manufactured from ONFLEX® K-6200-A40 styrenic block copolymer by PolyOne Corporation, but it can be made from other appropriate materials. The material for the bottom overmold 22 is also chosen to be opaque so as to hide from view the internal components of the assembled remote control unit 10. A pair of notches 116a, 116b is formed in the bottom overmold 22 adjacent its narrow end, each of the notches 116a, 116b being sized and shaped to correspond with the notches 112a, 112b, respectively, in the back shell member 14. Apertures 118a, 118b are formed in the notches 116a, 116b, respectively, extending completely through the bottom overmold 22. The apertures 118a, 118b are aligned with the apertures 110a, 110b, respectively, in the back shell member 14, thereby enabling the recharging contacts 28a, 28b to remain exposed for electrical contact with a recharging unit (not shown in the Figures). A pair of annular projections 120a, 120b is formed on the bottom overmold 22, each of the projections 120a, 120b mating with a corresponding one of the annular projections 114a, 114b on the back shell member 14 to ensure proper alignment of the bottom overmold 22 with the back shell member 14. Feet 122 extend outwardly from the exterior surface of the bottom overmold 22 to allow the remote control unit 10 to rest on a flat surface (not shown in the Figures), while a plurality of parallel grooves 124 is formed in the exterior surface of the bottom overmold 22 to assist a user in gripping the unit 10.

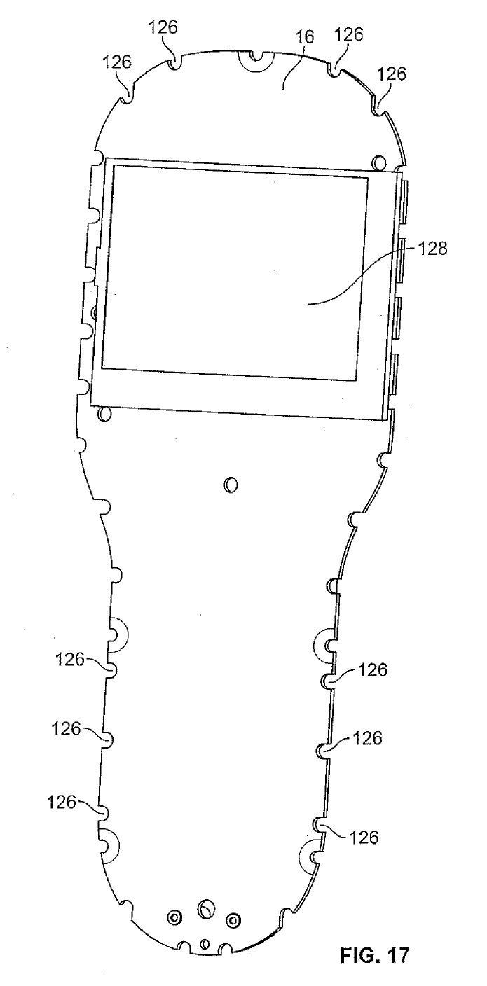

Referring now to FIG. 17, the printed circuit board 16 is sized and shaped for housing within the front and back shell members 12, 14 when they are fastened to each other. More particularly, a plurality of notches 126 is formed around the perimeter of the printed circuit board 16, each of the notches 126 being sized and shaped to receive either one of the posts 102 of the back shell member 14 or one the assembly screws 64 for maintaining the printed circuit board 16 in a stationary position. A rectangular-shaped LCD panel 128 is positioned adjacent the wide end of the printed circuit board 16 in alignment with the viewing screen 32 on the front shell member 12. The LCD panel 128 is connected electrically with the electronic components 24 of the printed circuit board 16.

Referring now to FIGS. 18 and 19, the remote control unit 10 is depicted after it has undergone a fourth overmolding operation in order to incorporate the center overmold 30, which makes the unit 10 completely waterproof (see FIG. 19). Like the other overmolding operations, the fourth overmolding operation is carried out using known injection molding techniques and materials. The material for the center overmold 30 is softer than the relatively hard plastic chosen for the front shell member 12, thereby providing a more tactile feel. Like the top and bottom overmolds 20, 22, the center overmold 30 may also be manufactured from ONFLEX® K-6200-A40 styrenic block copolymer by PolyOne Corporation, but it can be made from other appropriate materials. The material for the center overmold 30 is also chosen to be opaque so as to hide from view the internal components of the assembled remote control unit 10. The center overmold 30 is applied intermediate the top overmold 20 and the bottom overmold 22 and conceals a joint 130 formed between the front and back shell members 12, 14 when they are attached to one another. The application of the overmolds 20, 22, 30 to the front and back shell members 12, 14 as described above makes the remote control unit 10 completely waterproof and buoyant so that the unit can actually float in a pool or spa. As a result, the electronic components 24 are prevented from being damaged or destroyed by contact with water, thereby maintaining the operating life of the remote control unit 10.

Referring now to FIG. 20, the remote control unit 10 is shown with the LCD panel 128 displaying visual data and with a schematic illustration of its operating environment. More particularly, the remote control unit 10 is in radio frequency communication with a pool/spa centralized control system 130 which, in turn, is in communication with various pool/spa accessories 132, such as pumps, filters, heaters, lights, chlorinators, and cleaners. Programming each of the pool/spa accessories 132 may be accomplished by the user from around the pool or spa, which is typically remote from the centralized control system 130. For example, the user can select the pool/spa accessory 132 desired to be programmed by depressing the selection button 84a, 84b, 84c that corresponds to the accessory indicia 134a, 134b, 134c depicted visually on the LCD panel 128. It is noted that the remote control unit 10 can be operated to scroll through and display additional accessory indicia 134d, 134e, 134f, 134g (shown in phantom) that are not initially displayed on the panel 128. Once the desired accessory 132 is chosen, the user depresses the menu button 68, the navigation buttons 70a, 70b and/or the adjustment buttons 72a, 72b, as applicable, to select and program the desired settings of the accessory 132 (e.g., the duration of the operation of the heater in order to achieve a desired water temperature; the duration of the operation of the pool lighting system; etc.), which are displayed on the LCD panel 128. The shutoff button 92 enables the user to remotely shutdown all of the pool/spa accessories 132 during an emergency situation. The LCD panel 128 may also display other indicia, such as signal strength, battery life, day-of-the-week/date/time, pool/spa water and air temperatures, and any other appropriate text messages, graphics and symbols. The LCD panel 128 may have either a monochrome or a color display and may be backlit for nighttime operation. The remote control unit 10 may also include a power button (not shown in the Figures) to turn the unit on or off.

While the remote control unit 10 includes the three selection buttons 84a, 84b, 84c, it may include more or less than three selection buttons. Likewise, the remote control unit 10 can include buttons or other user interface controls in addition to the menu button 68, the navigation buttons 70a, 70b, the adjustment buttons 72a, 72b, and the shutoff button 92. In addition, the button group 18 may be backlit for nighttime operation.

As indicated above, the remote control unit 10 is buoyant so that it may be used in or around the pool or spa. Because the remote control unit 10 is capable of floating on the water surface of the pool/spa, a user can easily locate it. Also, the remote control unit 10 is adapted to resist environmental elements, such as UV rays from the sun and chlorine, in order to prevent the color of the unit from fading.

Because the remote control unit 10 is a self-contained, sealed, wireless unit, the software employed by the unit is capable of being updated wirelessly. For example, the remote control unit 10 may be adapted to employ RF “over-the-air” (OTA) updating software, which would enable the unit's software to be remotely updated. New software that patches any existing flaws in or updates the software originally installed on the remote control unit 10 may be delivered OTA, thus eliminating the need for the user to bring the unit to a service facility or send it to the manufacturer, which is relatively inefficient and expensive.

It should be understood that the embodiment described herein is merely exemplary and that a person skilled in the art may make many variations and modifications without departing from the spirit and scope of the invention. Accordingly, all such variations and modifications are intended to be included within the scope of the present invention.

What is claimed is:

1. A waterproof remote control unit for remotely controlling a pool or spa accessory, comprising:
a front shell member interconnected with a back shell member;
a printed circuit board including electrical components in wireless communication with a central controller for remotely controlling a pool or spa accessory, the printed circuit board positioned between the front and back shell members;
at least one button extending through an aperture in the front shell member for operating an electrical component of the printed circuit board, the button overmolded to the front shell member to provide a watertight seal between the button and the front shell member;
top and bottom overmolds overmolded to the front and back shell members, respectively; and
a center overmold overmolded to the front and back shell members,
wherein the top, bottom, and center overmolds establish a watertight seal for the remote control unit.

2. The remote control unit of claim 1, wherein the remote control unit is buoyant.

3. The remote control unit of claim 1, wherein the electrical components further comprise a liquid crystal display for displaying information about a remote pool or spa accessory and the front shell member includes a transparent window to allow viewing of the liquid crystal display.

4. The remote control unit of claim 3, wherein the liquid crystal display displays a menu for controlling a remote pool or spa accessory.

5. The remote control unit of claim 1, wherein the front shell member includes a ledge for overmolding the button to the front shell member.

6. The remote control unit of claim 1, further comprising a plurality of buttons for operating the electrical components of the printed circuit board to remotely control a pool or spa accessory.

7. The remote control unit of claim 6, wherein the plurality of buttons extend through a plurality of apertures formed in the front shell member.

8. The remote control unit of claim 7, wherein the plurality of buttons are overmolded to the front shell member to provide a watertight seal between the front shell member and the plurality of buttons.

9. The remote control unit of claim 1, wherein the bottom overmold comprises a pair of feet for resting the remote control unit on a surface.

10. The remote control unit of claim 9, wherein the bottom overmold comprises a plurality of grooves for assisting a user to grip the remote control unit.

11. The remote control unit of claim 1, wherein the electrical components further include a battery and the remote control unit further comprises a pair of contacts extending through the bottom shell member and the bottom overmold, the contacts in electrical communication with the battery and a charger for charging the battery.

12. A method for making a waterproof remote control unit for remotely controlling a pool or spa accessory, comprising the steps of:
providing a front shell member, a back shell member, and a printed circuit board including electrical components for remotely controlling a pool or spa accessory;
overmolding at least one button to the front shell member to provide a watertight seal between the front shell member and the button, the button extending through an aperture formed in the front shell member and operable to control an electrical component of the printed circuit board;
overmolding a top overmold to the front shell member and a bottom overmold to the back shell member;
positioning the printed circuit board between the front shell member and the back shell member and interconnecting the front shell member to the back shell member; and
overmolding a center overmold to the front and back shell members,
wherein the top, bottom, and center overmolds establish a watertight seal for the remote control unit.

13. The method of claim 12, further comprising overmolding a plurality of buttons to the front shell member prior to interconnecting the front shell member to the back shell member, the plurality of buttons extending through apertures formed in the front shell member and providing a watertight seal between the plurality of buttons and the front shell member, the plurality of buttons operable to control electrical components of the circuit board.

14. The method of claim 12, further comprising forming a pair of feet on the bottom overmold for resting the remote control unit on a surface.

15. The method of claim 12, further comprising forming a plurality of grooves on the bottom overmold for assisting a user to grip the remote control unit.

16. The method of claim 12, further comprising attaching electrical contacts to the bottom overmold and interconnecting the electrical contacts with a battery for powering the electrical components, the electrical contacts connectable to a charger for charging the battery.
